(19) United States
(12) Patent Application Publication
(10) Pub. No.: US 2020/0030997 A1
(43) Pub. Date: Jan. 30, 2020

(54) SAFETY UTILITY BLADES, ASSEMBLIES AND METHODS OF MANUFACTURING

(71) Applicant: KLEVER KUTTER LLC, Grand Haven, MI (US)

(72) Inventors: Matthew Jacobs, Grand Haven, MI (US); Jeffrey Kempker, Muskegon, MI (US); Orville Crain, Muskegon, MI (US)

(21) Appl. No.: 16/571,126

(22) Filed: Sep. 15, 2019

Related U.S. Application Data
(63) Continuation of application No. 13/866,074, filed on Apr. 19, 2013, now Pat. No. 10,442,093.

(51) Int. Cl. B26B 5/00; B26B 25/00; B25F 1/02; B25G 1/10; B25G 3/18; B26B 27/00; B26B 9/00

(52) U.S. Cl. CPC B26B 5/00; B26B 25/005; B25F 1/02; B26B 9/00; B25G 3/18; B26B 27/005; B25G 1/102

(57) ABSTRACT

The present disclosure relates to safety blades for use in utility knives, related assemblies and methods of manufacturing. More specifically, the present disclosure relates to safety blades for use in utility knives, related assemblies and methods of manufacture which limit user exposure to associated cutting edges.

### RELATED APPLICATIONS

This application is a continuation of U.S. patent application Ser. No. 13/866,074, which was filed on Apr. 19, 2013, the entire disclosure of which is incorporated herein by reference.

### FIELD OF THE INVENTION

The present disclosure relates to replaceable safety blades for use in utility knives, related assemblies and methods of manufacturing. More specifically, the present disclosure relates to replaceable safety blades for use in utility knives, related assemblies and methods of manufacture which limit user exposure to an associated blade cutting edge.

### BACKGROUND

Utility knives are used for a host of purposes, such as opening cardboard boxes, cutting sheet material, cutting web material, opening packages, etc. Injuries to the users of utility knifes are all too common due to inadvertent contact with the cutting edges of the associated blades. Injuries may be particularly severe when the given utility knife includes a razor blade.

Inadvertent contact with the cutting edges of blades can be equally common during blade removal, insertion and handling. Inadvertent contact with the cutting edges is particularly problematic when a user is removing or inserting a double edge razor blade into an associated utility knife.

Blades for use in utility knives and utility knives which limit user exposure to the associated cutting edges are desirable. Methods of manufacturing related blades and utility knives are also desirable.

### SUMMARY

A replaceable safety blade for use within a utility knife assembly may include a blade body having a cutting edge. The blade body and the cutting edge define a contiguous piece of metal. The replaceable safety blade may also include a blade attachment having a blade tip and a first edge. The first edge and the blade tip may be juxtapose on opposite ends of the cutting edge. The blade attachment may further include a bottom edge extending between the first edge and the second edge defining a width of the blade attachment. The replaceable safety blade may further include a handle adaptor having a handle engagement portion with a handle securing mechanism. The handle adaptor may be secured to the blade attachment portion. The handle engagement portion may be configured to removably secure the replaceable safety blade to a handle. The handle engagement portion may extend from a bottom edge of the blade body. A width of the handle adaptor may be less than the width of the blade attachment. The handle engagement and the blade tip may extend beyond the blade cutting edge. The blade tip portion and an edge of the handle adaptor may form a first blade throat which may limit exposure to a blade cutting edge.

In another embodiment, a method of manufacturing the safety blade for use within a safety utility knife assembly may include providing a strip of blade material, forming a blade cutting edge, and forming a rough blade shape from the strip of blade material, wherein the rough blade shape comprises a blade body. The method may also include forming a blade attachment having a blade tip and a first edge. The first edge and the blade tip may be juxtapose on opposite ends of the cutting edge. The blade attachment may further include a bottom edge extending between the first edge and the second edge defining a width of the blade attachment. The method may further include forming a handle adaptor having a handle engagement portion with a handle securing mechanism. The handle adaptor may be secured to the blade attachment portion. The handle engagement portion may be configured to removably secure the replaceable safety blade to a handle. The handle engagement portion may extend from a bottom edge of the blade body. A width of the handle adaptor may be less than the width of the blade attachment. The handle engagement and the blade tip may extend beyond the blade cutting edge. The blade tip portion and an edge of the handle adaptor may form a first blade throat which may limit exposure to a blade cutting edge.

In a further embodiment, a safety utility knife assembly may include a replaceable safety blade and a handle for engagement with the handle engagement of the handle adaptor.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE FIGURES

FIGS. 1a and 1b depict an example safety utility blade for use within a utility knife assembly;

FIG. 2 depicts the safety utility blade of FIGS. 1a and 1b in proximity to a human finger;

FIG. 3A depicts an example progression of manufacturing the safety utility blade of FIGS. 1a, 1b and 2;

FIG. 3B depicts an example blade edge grinding and honing drum apparatus;

FIG. 3C depicts an example blade edge grinding and honing wheel;

FIG. 3D depicts an example flow diagram for a method of manufacturing the safety utility blade of FIG. 3A;

FIG. 3E depicts an example flow diagram for a method of manufacturing the safety utility blade of FIGS. 4A-4D;

FIGS. 4A-4D depict a second example progression of manufacturing the safety utility blade of FIGS. 1A, 1B and 2;

FIGS. 5A and 5B depict examples of safety cutter heads which include a safety utility blade of FIGS. 1a, 1b, 2, 3A and 4A-4D;

FIG. 6 depicts the safety cutter head of FIG. 5B proximate an associated safety utility knife handle;

FIG. 7 depicts the safety cutter head of FIG. 5B engaged with an associated safety utility knife handle to form a safety utility knife assembly;

FIGS. 8A-8H and 8J-8K depict an example safety utility knife assembly;

FIGS. 9A-9H and 9J depict an example blade carriage for use within the safety utility knife assembly of FIGS. 9A-9H and 9J;

FIG. 10A depicts an example progression of manufacturing a blade for use in the safety utility knife assembly of FIGS. 9A-9H and 9J;

FIGS. 10B-10D depict a second example progression of manufacturing a blade for use in the safety utility knife assembly of FIGS. 9A-9H and 9J;

FIG. 10E depicts an example flow diagram for a method of manufacturing the safety blade of FIG. 10A;

FIG. 10F depicts an example flow diagram for a method of manufacturing the safety blade of FIGS. 10B-10D; and

FIG. 11 depicts an example safety utility blade for use in a safety utility knife assembly as in FIGS. 9A-9H and 9J.

### DETAILED DESCRIPTION

The safety utility blades and safety utility knife assemblies of the present disclosure incorporate various features that limit user exposure to associated cutting edges. The manufacturing methods of the present disclosure may be used to produce the disclosed safety utility blades and safety utility knife assemblies.

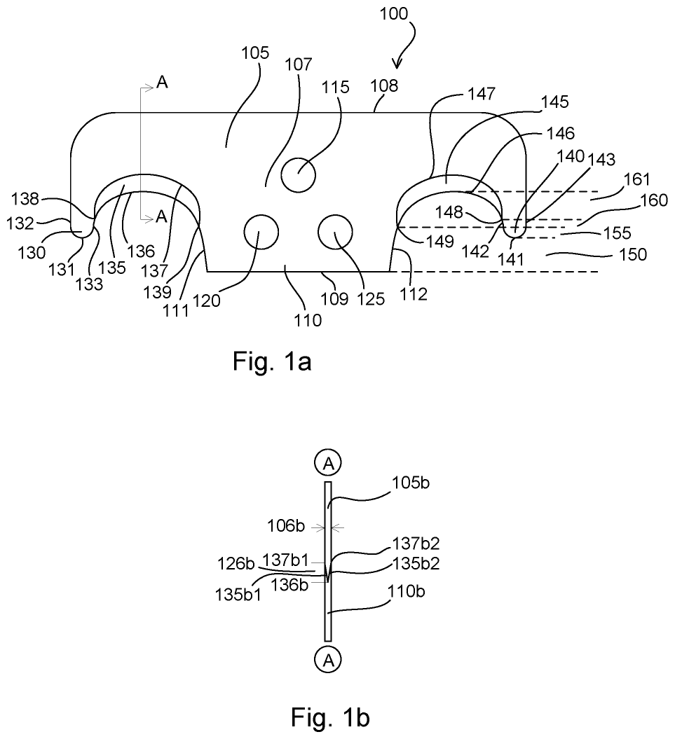

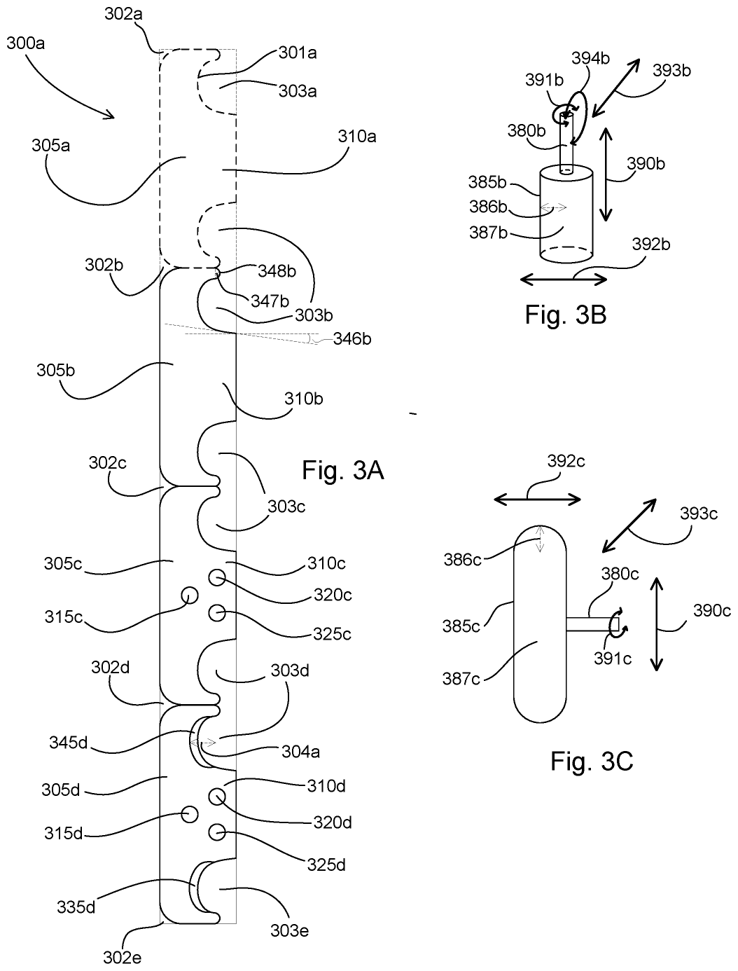

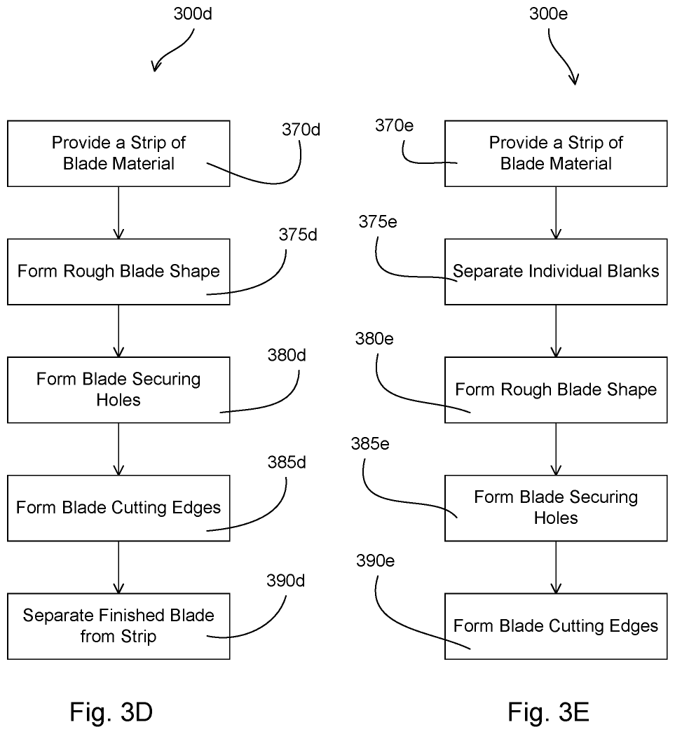

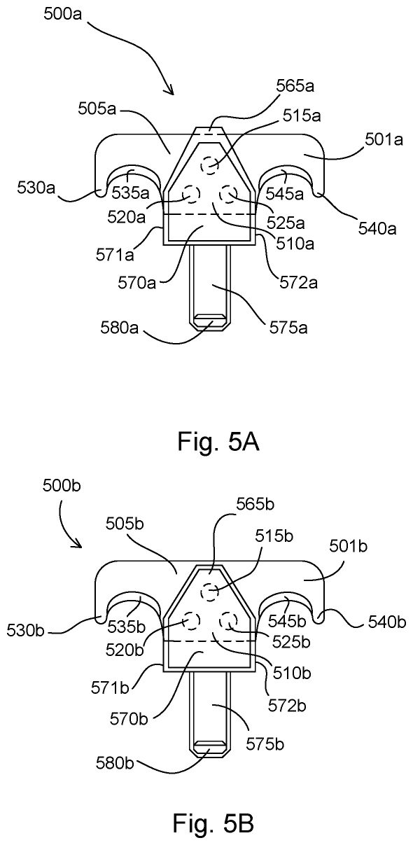

With initial reference to FIGS. 1A and 1B, a safety utility blade 100 may have a body 105 formed from a relatively thin and substantially flat material 107, such as ceramic, heat treated carbon steel, ceramic coated steel, stainless steel, Teflon coated material, etc. For example, the material 107 may be approximately 0.025 inches thick 106b. A blade blank (e.g. blade blank 300a, 400a, 1000a, 1000b of FIGS. 3A, 4A, 10A and 10B, respectively) may be 1.0964567 inches from a first end 132 to a second end 142 and 0.3917323 inches from a top side 108 to a bottom side 109. The safety utility blade may include blade securing holes 115, 120, 125 which may be approximately 0.0984252 inches in diameter. As described herein the blade securing holes 115, 120, 125 may, at least in part, secure a safety utility blade 100 to a safety utility knife cutting head (e.g., safety utility knife cutting head 500a of FIG. 5A or 500b of FIG. 5B). The safety utility blade 100 may be formed from a suitable material 107 for retaining a sharpened edge 136, 137, and, when that material 107 is metal, the body 105 preferably has a thickness 106b of at least 0.0156 inches and preferably not greater than about 0.0313 inches. What might be characterized as a “heavy-duty” safety utility blade 100 is approximately 0.025 inches thick, and the thickness 106b for what might be characterized as a “regular duty” safety utility blade 100 is approximately 0.017 inches. The sharpened portion 135, 145 is approximately 0.0492 inches high. A center of the first blade securing hole 115 may be approximately 0.23622 inches from the bottom side 109 and approximately 0.54825 inches from the first end 132. A center of the second blade securing hole 120 may be approximately 0.07874 inches from the bottom side 109 and approximately 0.449825 inches from the first end 132. A center of the third blade securing hole 125 may be approximately 0.07874 inches from the bottom side 109 and approximately 0.449825 inches from the second end 142. The sharpened portion 135, 145 may be coated with a material, such as paint, that may wear away as the associated safety utility blade 100 is being used to indicate whether the safety utility blade 100 has been used. The consistency of the material, such as paint, may be selected such that the amount of wear of the material is indicative of the amount of use of and/or the sharpness of the safety utility blade 100.

With further reference to FIGS. 1A and 1B, the safety utility blade 100 may include a body portion 105, 105b and a blade attachment portion 110, 110b. The first sharpened portion 135 of the safety utility blade 100 may include a first shoulder 137, a first cutting edge 136, a first heal 139 and a first toe 138. The blade attachment portion 110, 110b may include a first edge 111 extending from the first heal 139 to the bottom side 109. The safety utility blade 100 may further include a first blade shield 130 having a first blunt tip 131 having a radius approximately 0.03937 inches and a thickness that is greater than the first sharpened portion 135 and less than or equal to the thickness 106b of the body 105. The first blade shield 130 may include a first inner edge 133 that extends from the first toe 139 to the first blunt tip 131 and may have a thickness that is greater than the first sharpened portion 135 and less than or equal to the thickness 106b of the body 105, 105b. A first distance 126b between the first shoulder 137 and the first cutting edge 136 may be approximately 0.04921 inches.

With further reference to FIGS. 1A and 1B, the safety utility blade 100 may include a second sharpened portion 145 which may include a second shoulder 147, a second cutting edge 146, a second heal 149 and a second toe 148. The blade attachment portion 110, 110b may include a second edge 112 extending from the second heal 149 to the bottom side 109. The safety utility blade 100 may further include a second blade shield 140 having a second blunt tip 141 having a radius approximately 0.03937 inches and a thickness that is greater than the second sharpened portion 145 and less than or equal to the thickness 106b of the body 105. The second blade shield 140 may include a second inner edge 143 that extends from the second toe 149 to the second blunt tip 141 and may have a thickness that is greater than the second sharpened portion 145 and less than or equal to the thickness 106b of the body 105. A second distance 150 between the bottom side 109 and the second blunt tip 141 may be approximately 0.05315 inches. A third distance 155 between the bottom side 109 and the second heal 149 may be approximately 0.0687 inches. A fourth distance 160 between the bottom side 109 and the second toe 148 may be approximately 0.0774 inches. A fifth distance 161 between the bottom side 109 and the second cutting edge 146 may be approximately 0.1496 inches. As depicted in FIG. 1b, the cutting edge 136b may be defined by a third sharpened portion 135b1 extending from a third shoulder 137b1 and a fourth sharpened portion 135b2 extending from a fourth shoulder 137b2. It should be understood that either of the cutting edges 136, 146 may be formed similar to cutting edge 136b. The sharpened portion 135, 145, the third sharpened portion 135b1 and/or the fourth sharpened portion 135b2 may be substantially concave or convex shaped. Alternatively, a portion of the sharpened portion 135, 145, a portion of the third sharpened portion 135b1 and/or a portion of the fourth sharpened portion 135b2 may be substantially concave or convex shaped with the remainder defining a linear shape.

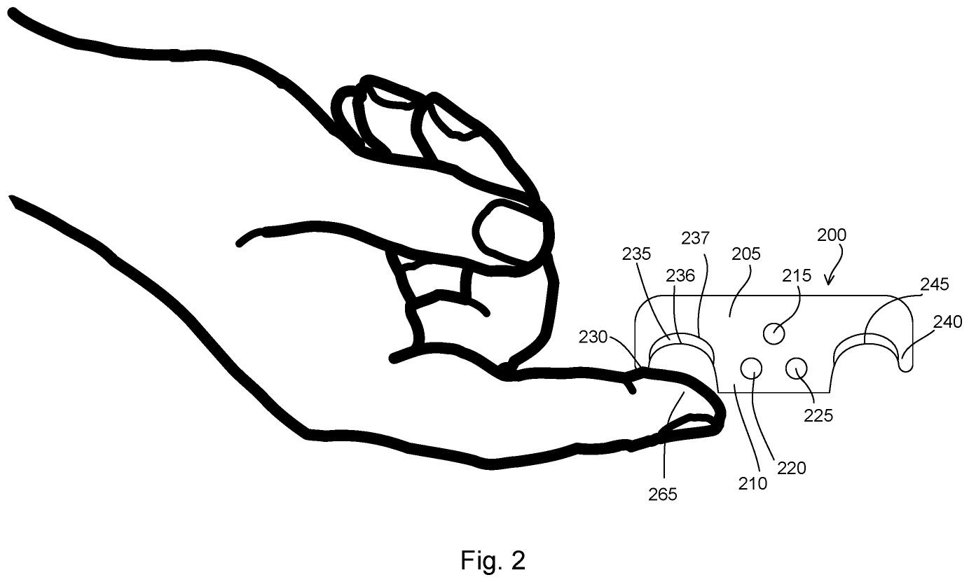

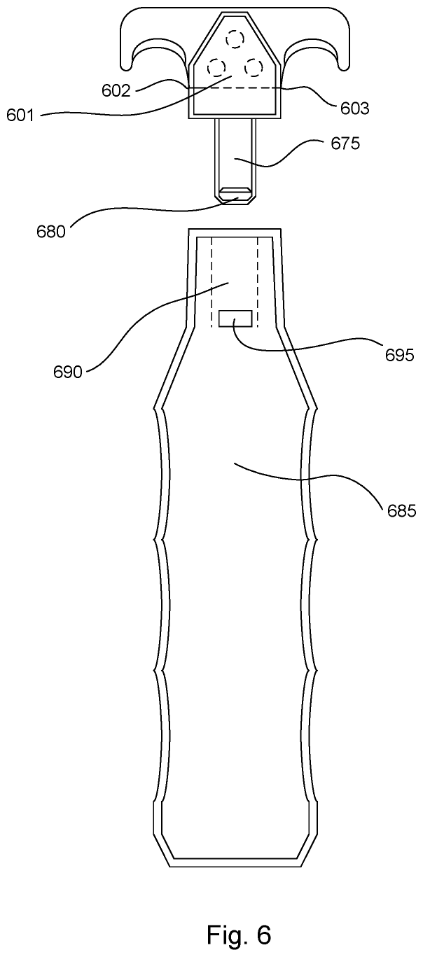

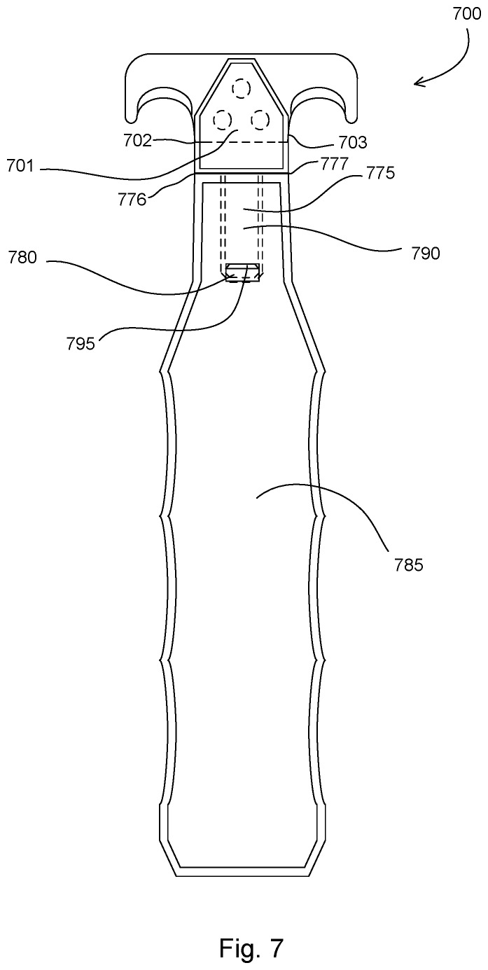

Turning to FIG. 2, a safety utility blade 200 is depicted proximate a human finger 265. The safety utility blade 200 may be similar to the safety utility blade 100 of FIGS. 1A and 1B having a first sharpened portion 235 defining a first shoulder 237 and a first cutting edge 236. As can be seen in FIG. 2, a first blade shield 230 may cooperate with the blade attachment portion 210 to limit access of the human finger 265 to the first cutting edge 236. Similarly, the second blade shield 240 may cooperate with the blade attachment portion 210 to limit access to the second sharpened portion 245. In either event, the safety utility blade 200 may be configured to limit access to associated cutting edges while the safety utility blade is being removed from an associated package, being inserted in a corresponding safety utility knife assembly (e.g., safety utility knife assembly 700 of FIG. 7), when being removed from a corresponding safety utility knife assembly and while being used within a corresponding safety utility knife assembly. The safety utility blade 200 may have a body portion 205 constructed similar to the body portion 105. The safety utility blade 200 may include blade securing holes 215, 220, 225 for securing the safety utility blade 200 to a corresponding safety cutting head (e.g., either safety cutting head 500a or 500b of FIGS. 5A and 5B, respectively) or securing the safety utility blade to a handle (e.g., a handle 685 of FIG. 6).

With reference now to FIGS. 3A-3D, a method 300d of manufacturing a safety utility blade (e.g., safety utility blade 100 of FIG. 1) is described. A strip of blade material 300a is provided (block 370d). The individual rough blade shapes 301a may remain attached to one another while each of the individual steps 375d-385d are performed. A rough blade shape 301a is formed in the strip of blade material 300a (block 375d) by removing material 302a, 303a, 302b, 303b. The material 302a, 303a, 302b, 303b may be removed from the strip of blade material 300a by laser cutting, machining, water jet cutting, stamp shearing or any other suitable technique. The material 302c, 303c, 302d, 303d, 302e, 303e may be removed prior to steps 380d, 385d being performed or the steps 380d, 385d may be performed on each rough blade shape 301a prior to removing the material 302c, 303c, 302d, 303d, 302e, 303e associated with the next rough blade shape 301a. An edge (e.g., edge 111 and/or 112 of FIG. 1) of the blade attachment portion 310b may form an angle 346b with respect to a blade bottom edge (e.g., bottom 109 of FIG. 1) of approximately 21.2° to encourage material to be cut to move toward the blade end 347b. The angle 346b may be between approximately 15° and approximately 25°. As can be seen in FIG. 3A, each rough blade shape 301a may include a blade body portion 305a, 305b, 305c, 305d and a blade attachment portion 310a, 310b, 310c, 310d. Blade securing holes 315c, 320c, 325c, 315d, 320d, 325d may be formed in each rough blade shape 301a (block 380d). The blade securing holes 315c, 320c, 325c, 315d, 320d, 325d may be formed by any suitable method, such as laser cutting, water jet cutting, machining, drilling, stamp shearing, etc.

With further reference to FIGS. 3A-3D, a first blade cutting edge 335d and a second blade cutting edge 345d may be formed in each rough blade shape 301a (block 385d). The first blade cutting edge 335d may be formed prior to the second blade cutting edge 345d or the first blade cutting edge 335d and the second blade cutting edge 345d may be formed simultaneously. The first blade cutting edge 335d and the second blade cutting edge 345d may be formed using a blade edge grinding and honing drum 385b, a blade edge grinding and honing wheel 385c or any other suitable method. The blade edge grinding and honing drum 385b may have a radius 386b that is substantially the same as the desired cutting edge radius 304a. The blade edge grinding and honing drum 385b may include a grinding surface 387b of any desired roughness and hardness to form the sharpened surface portion (e.g., sharpened surface portion 335d, 345d). As depicted in FIG. 3B, the blade edge grinding and honing drum 385b may include a spindle 380b for attaching the blade edge grinding and honing drum 385b to an associated driving and actuating machine (not shown) to rotate the blade edge grinding and honing drum 385b or move the blade edge grinding and honing drum 385b in any combination of a x-direction 392b, a y-direction 390b and a z-direction 393b relative to the strip of blade material 300a to produce a sharpened portion 135, 145, 135b1, 135b2. Alternatively, the strip of blade material 300a may be oriented and moved in any one of or a combination of a x-direction 392b, a y-direction 390b and a z-direction 393b relative to the blade edge grinding and honing drum 385b to produce a sharpened portion 135, 145, 135b1, 135b2. The blade edge grinding and honing drum 385b may be rotated about a central axis 391b to produce a grinding and honing motion of the grinding surface 387b relative first blade cutting edge 335d and the second blade cutting edge 345d. The blade edge grinding and honing drum 385b rotated into position around a pivot axis 394b when a corresponding rough blade shape 305c is moved into an appropriate position relative the blade edge grinding and honing drum 385b.

Alternatively, the first blade cutting edge 335d and the second blade cutting edge 345d may be formed using a blade edge grinding and honing wheel 385c or any other suitable method. The blade edge grinding and honing wheel 385c may have a radius 386c that is substantially the same as the desired cutting edge radius 304a. The blade edge grinding and honing wheel 385c may include a grinding surface 387c of any desired roughness and hardness to form the sharpened surface portion (e.g., sharpened surface portion 335d, 345d). As depicted in FIG. 3C, the blade edge grinding and honing wheel 385c may include a spindle 380c for attaching the blade edge grinding and honing wheel 385c to an associated driving and actuating machine (not shown) to rotate the blade edge grinding and honing wheel 385c and/or move the blade edge grinding and honing wheel 385c in any combination of a x-direction 392c, a y-direction 390c and a z-direction 393c relative to the strip of blade material 300a to produce a sharpened portion 135, 145, 135b1, 135b2. Alternatively, the strip of blade material 300a may be oriented and moved in any one of or a combination of a x-direction 392c, a y-direction 390c and a z-direction 393c relative to the blade edge grinding and honing wheel 385c to produce a sharpened portion 135, 145, 135b1, 135b2. The blade edge grinding and honing wheel 385c may be rotated about a central axis 391c to produce a grinding and honing motion of the grinding surface 387c relative first blade cutting edge 335d and the second blade cutting edge 345d. The blade edge grinding and honing wheel 385c rotated into position around a pivot axis 394c when a corresponding rough blade shape 305c is moved into an appropriate position relative the blade edge grinding and honing wheel 385c.

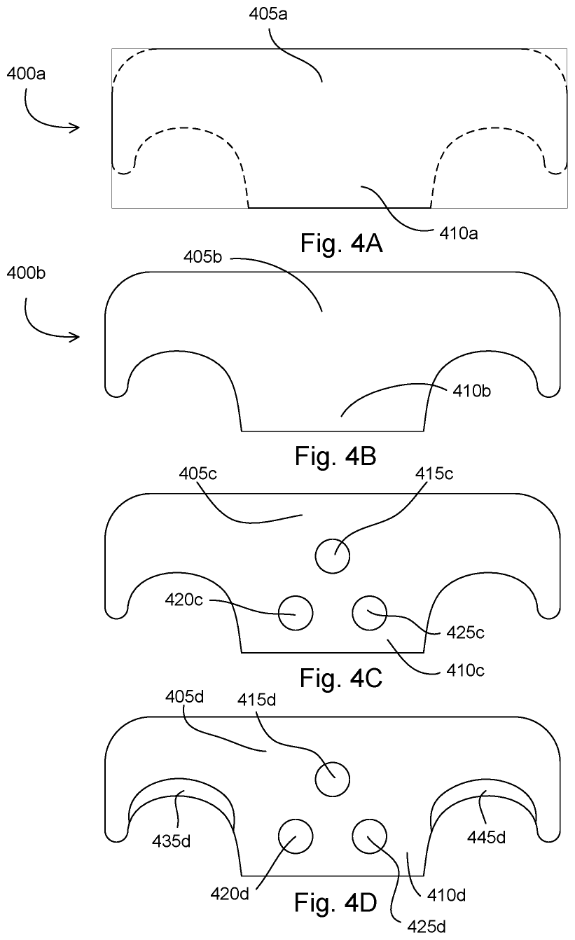

Once the blade securing holes 315c, 320c, 325c and the sharpened surface portions 335d, 345d are formed in a respective rough blade shape 301a, the finished safety utility blade 100 may be separated from the strip of blade material 300a (block 390d). Alternatively, with reference to FIGS. 3E and 4A-4D, a strip of blade material 300a may be provided (block 370e) and individual blade blanks 400a may be separated from the strip of blade material 300a (block 375e). Rough blade shapes 400b may be formed from the individual blade blanks 400a by laser cutting, machining, water jet cutting, stamp shearing or any other suitable technique (block 380e). The rough blade shapes may include a blade body portion 405a, 405b, 405c, 405d and a blade attachment portion 410a, 410b, 410c, 410d. Blade securing holes 415c, 420c, 425c, 415d, 420d, 425d may be formed in the rough blade shapes by any suitable method, such as laser cutting, water jet cutting, machining, drilling, stamp shearing, etc. (block 385e).

With further reference to FIGS. 3E and 4A-4D, a first blade cutting edge 435d and a second blade cutting edge 445d may be formed in each rough blade shape 400a (block 390d). The first blade cutting edge 435d may be formed prior to the second blade cutting edge 445d or the first blade cutting edge 435d and the second blade cutting edge 445d may be formed simultaneously. The first blade cutting edge 435d and the second blade cutting edge 445d may be formed using a blade edge grinding and honing drum 385b, a blade edge grinding and honing wheel 385c or any other suitable method. The blade edge grinding and honing drum 385b may have a radius 386b that is substantially the same as the desired cutting edge radius 304a. The blade edge grinding and honing drum 385b may include a grinding surface 387b of any desired roughness and hardness to form the sharpened surface portion (e.g., sharpened surface portion 435d, 445d). As depicted in FIG. 3B, the blade edge grinding and honing drum 385b may include a spindle 380b for attaching the blade edge grinding and honing drum 385b to an associated driving and actuating machine (not shown) to rotate the blade edge grinding and honing drum 385b or move the blade edge grinding and honing drum 385b in any combination of a x-direction 392b, a y-direction 390b and a z-direction 393b relative to the rough blade shape 400b. Alternatively, the rough blade shape 400b may be oriented and moved in any one of or a combination of a x-direction 392b, a y-direction 390b and a z-direction 393b relative to the blade edge grinding and honing drum 385b.

Alternatively, the first blade cutting edge 435d and the second blade cutting edge 445d may be formed using a blade edge grinding and honing wheel 385c or any other suitable method. The blade edge grinding and honing wheel 385c may have a radius 386c that is substantially the same as the desired cutting edge radius 304a. The blade edge grinding and honing wheel 385c may include a grinding surface 387c of any desired roughness and hardness to form the sharpened surface portion (e.g., sharpened surface portion 435d, 445d). As depicted in FIG. 3C, the blade edge grinding and honing wheel 385c may include a spindle 380c for attaching the blade edge grinding and honing wheel 385c to an associated driving and actuating machine (not shown) to rotate the blade edge grinding and honing wheel 385c and/or move the blade edge grinding and honing wheel 385c in any combination of a x-direction 392c, a y-direction 390c and a z-direction 393c relative to the rough blade shape 400b. Alternatively, the rough blade shape 400b may be oriented and moved in any one of or a combination of a x-direction 392c, a y-direction 390c and a z-direction 393c relative to the blade edge grinding and honing wheel 385c.

Whether the safety utility blade 100 is completed prior to separating the rough blade shapes 301a from the strip of blade material 300a or the safety utility blade 100 is completed after the individual blade blanks 400a are separated from a strip of blade material 300a, a series of grinding and honing drums 385b and/or grinding and honing wheels 385c may be used to form the sharpened surface portion 335d, 345d, 435d, 445d. Each grinding and honing drum 385b and/or grinding and honing wheel 385c in a series of grinding and honing drums 385b and/or grinding and honing wheels 385c may have a progressively finer and finer grinding and honing surface 387b, 387c relative to the preceding grinding and honing drum 385b and/or grinding and honing wheel 385c in the series.

Turning to FIG. 5A, a safety cutting head 500a is depicted including a safety utility blade 501a attached to a handle adaptor 570a. The safety utility blade 501a may include a blade body portion 505a, an blade attachment portion 510a, blade securing holes 515a, 520a, 525a, a first sharpened portion 535a, a first blade shield 530a, a second sharpened portion 545a and a second blade shield 540a. The handle adaptor 570a may include a body portion 565a having a first side 571a and a second side 572a. As depicted in FIG. 5A, the width of the body portion 565a may be substantially equal the width of the blade attachment portion 510a. As also depicted in FIG. 5A, the body portion 565a may extend beyond the blade body portion 505a. The extension of the body portion 565a may cooperate with the securing holes 515a, 520a, 525a to secure the safety utility blade 501a to the handle adaptor 570a. For example, the handle adaptor may be made of a thermal plastic material and may be co-molded around the safety utility blade 501a such that the thermal plastic material penetrates through the blade securing holes 515a, 520a, 525a and form a mirror half of the body portion 565a on either side of the safety utility blade 501a to encapsulate the blade body portion 505a of the safety utility blade 501a. The handle adaptor 570a may include a handle engagement portion 575a with a handle securing mechanism 580a to secure the safety cutting head 500a to a corresponding handle (e.g., handle 685 of FIG. 6).

Turning to FIG. 5B, a safety cutting head 500b is depicted including a safety utility blade 501b attached to a handle adaptor 570b. The safety utility blade 501b may include a blade body portion 505b, an blade attachment portion 510b, blade securing holes 515b, 520b, 525b, a first sharpened portion 535b, a first blade shield 530b, a second sharpened portion 545b and a second blade shield 540b. The handle adaptor 570b may include a body portion 565a having a first side 571b and a second side 572b. As depicted in FIG. 5A, the width of the body portion 565b may be substantially equal the width of the blade attachment portion 510b. The body portion 565b may cooperate with the securing holes 515b, 520b, 525b to secure the safety utility blade 501b to the handle adaptor 570b. For example, the handle adaptor may be made of a thermal plastic material and may be co-molded around the safety utility blade 501b such that the thermal plastic material penetrates through the blade securing holes 515b, 520b, 525b and form a mirror half of the body portion 565b on either side of the safety utility blade 501b to encapsulate the blade body portion 505b of the safety utility blade 501b. The handle adaptor 570b may include a handle engagement portion 575b with a handle securing mechanism 580b to secure the safety cutting head 500b to a corresponding handle (e.g., handle 685 of FIG. 6). A first side 571b and a second side 572b of a handle adaptor 570b may cooperate with a body portion 565b to form a “clamshell” and fasteners, such as metal pins, may be included to cooperate with the securing holes 515b, 520b, 525b to replaceably secure a safety utility blade 100 within a safety cutting head 500b. When a clamshell structure is provided, a handle engagement portion 575b may be configured with two halves with each halve being fixed to a respective side 571b, 572b of the handle adaptor 570b. When a safety utility blade 100 is placed within a clamshell structure and the clamshell structure is engaged with a handle 685, the safety utility blade 100 is secured within the clamshell structure of the safety cutting head 500b. The body portion 565b may be configured as a hinge mechanism within a clamshell structure and fasteners, such as metal pins, may be fixed to a respective side 571b, 572b of the handle adaptor 570b.

Turning to FIG. 6, a safety cutting head 601 is depicted proximate an associated handle 685. The safety cutting head 601 may include a first body side 602 and a second body side 603. The safety cutting head 601 may include a handle engagement 675 having a handle securing mechanism 680. The handle 685 may include a cutting head engagement 690 having a cutting head securing mechanism 695.

With reference now to FIG. 7, a safety utility knife assembly 700 is depicted including a safety cutting head 701 and a handle 785. The safety cutting head 701 may include a first side 702 that aligns with a first handle side 776 and a second side 703 that aligns with a second handle side 777 when the handle engagement 775 is secured to the cutting head engagement 790 via the handle securing mechanism 780 and the cutting head securing mechanism 795. A safety utility knife assembly 700 may be configured to store one or more additional safety cutting heads 701. For example, a second safety cutting head 701 may be secured to each end of the handle 785. Alternatively, the handle 785 may include a spare safety cutting head 701 retaining mechanism.

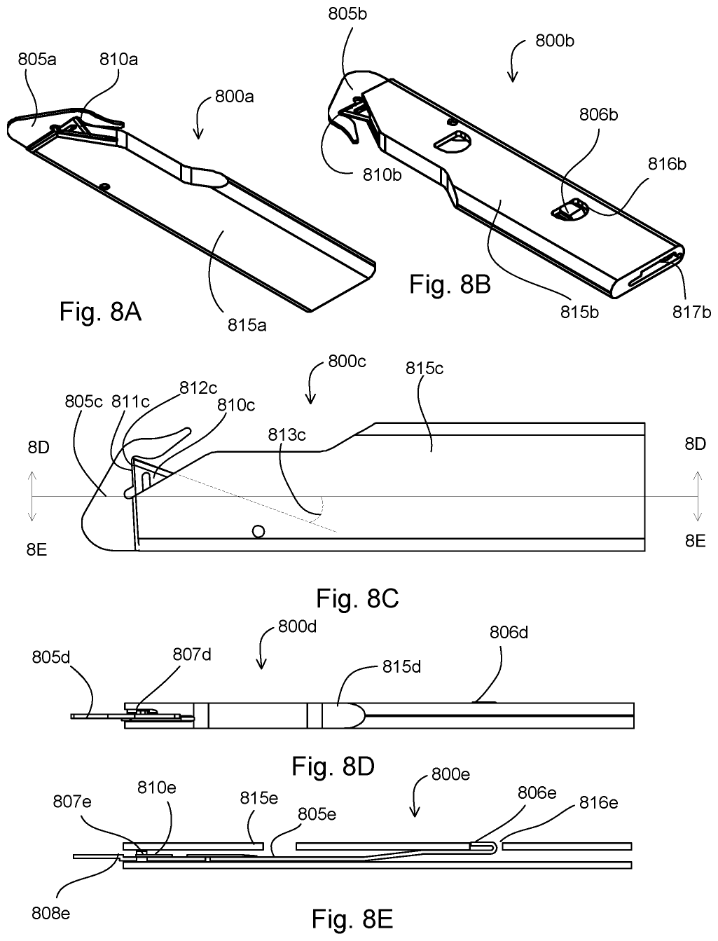

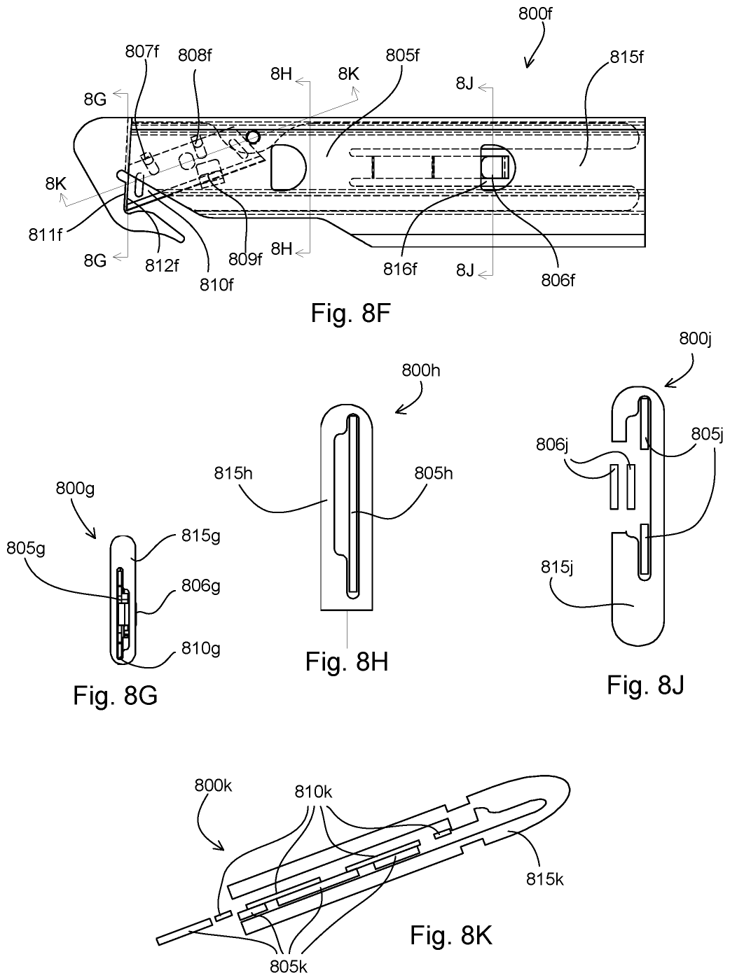

Turning now to FIGS. 8A-8H and 8J-8K, a safety utility knife assembly 800a, 800b, 800c, 800d, 800e, 800f, 800g, 800h, 800j, 800k is depicted including a blade 810a, 810b, 810c, 810e, 810f, 810g, 810k within a blade holder 805a, 805b, 805c, 805d, 805e, 805f, 805g, 805j, 805j, 805k inserted in a handle 815a, 815b, 815c, 815d, 815e, 815f, 815g, 815h, 815j, 815k. The blade holder 805a, 805b, 805c, 805d, 805e, 805f, 805g, 805j, 805j, 805k may include a handle engagement 806b, 806d, 806e, 806f, 806g, 806j a blade retaining offset 808e and blade retainer 807d, 807e. The handle 815a, 815b, 815c, 815d, 815e may include a blade holder engagement 816b, 816e, 816f that cooperates with the handle engagement 806b, 806d, 806e, 806g, 806j to secure the blade holder 805a, 805b, 805c, 805d, 805e, 805f, 805g, 805j, 805j, 805k within the handle 815a, 815b, 815c, 815d, 815e, 815f, 815g, 815h, 815j, 815k. The blade retaining offset 808e, a first blade retainer 807d, 807e, 807f, a second blade retainer 808f and a third blade retainer 809f cooperate with the handle 815a, 815b, 815c, 815d, 815e to secure the blade edge 812c, 812f proximate a blade retaining offset surface 811c, 811f. The safety utility knife assembly 800a, 800b, 800c, 800d, 800e, 800f, 800g, 800h, 800j, 800k may include a spare blade compartment to store unused blades 810a, 810b, 810c, 810e, 810f, 810g, 810k.

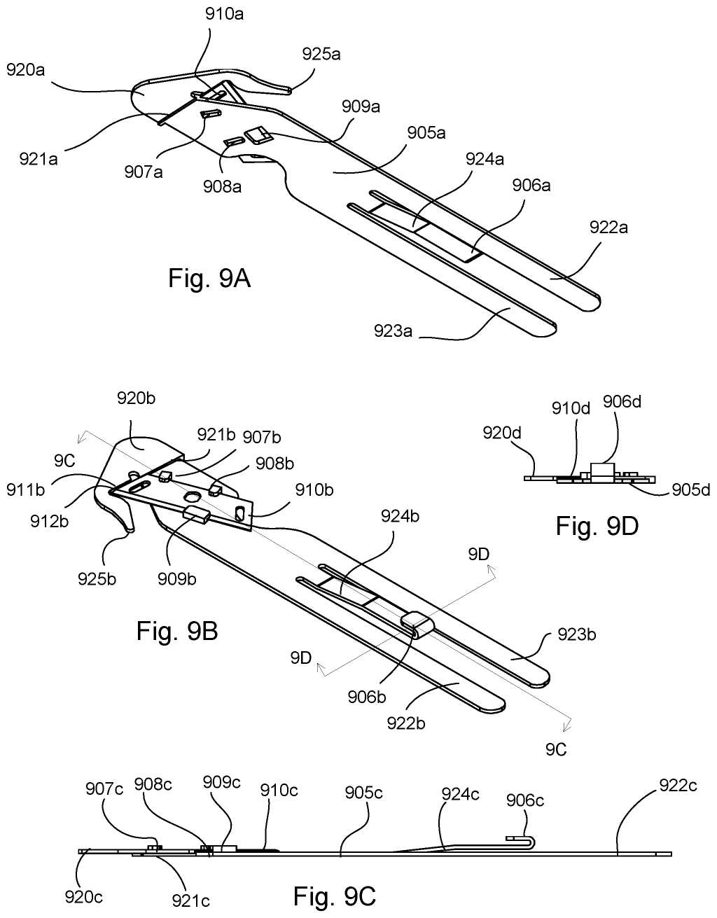

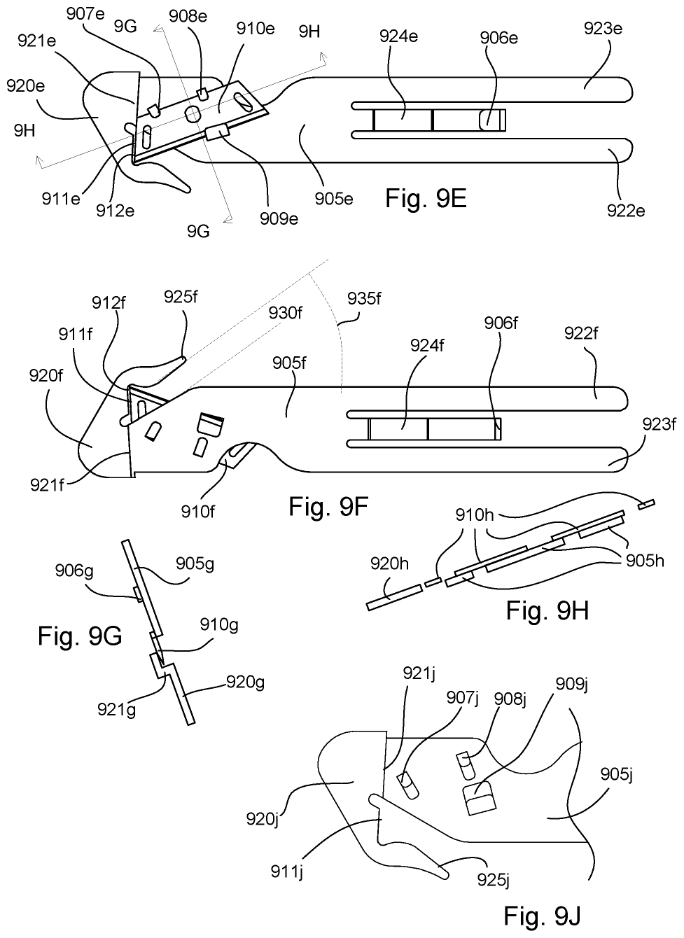

With reference to FIGS. 9A-9H and 9J a blade holder 905a, 905b, 905c, 905d, 905e, 905f, 905g, 905h, 905j is depicted including a blade edge 912b, 912e, 912f of blade 910a, 910b, 910c, 910d, 910e, 910f, 910g, 910h, 910j secured against a blade retaining offset surface 911b, 911e, 911f of the blade holder 905a, 905b, 905c, 905d, 905e, 905f, 905g, 905h, 905j by a first blade retainer 907a, 907b, 907c, 907e, 907j, a second blade retainer 908a, 908b, 908c, 908e, 908j and a third blade retainer 909a, 909b, 909c, 909e, 909j. A blade holder head 920a, 920b, 920c, 920d, 920e, d20f, 920g, 920h, 920j and blade shield 925a, 925b, 925f, 925j are offset from the blade holder 905a, 905b, 905c, 905d, 905e, 905f, 905g, 905h, 905j at offset surface 921a, 921b, 921c, 921e, 921f, 921g, 921j by a distance substantially equal to a thickness (e.g., thickness 106b of FIG. 1B) of the blade 910a, 910b, 910c, 910d, 910e, 910f, 910g, 910h, 910j. The blade holder 905a, 905b, 905c, 905d, 905e, 905f, 905g, 905h, 905j may include a first slide 922a, 922b, 922c, 922e, 922f and a second slide 923a, 923b, 923e, 923f that are received within a corresponding handle 815a, 815b, 815c, 815d, 815e, 815f, 815g, 815h, 815j, 815k and secured within the handle 815a, 815b, 815c, 815d, 815e, 815f, 815g, 815h, 815j, 815k with handle engagement mechanism 906a, 906b, 906c, 906d, 906e, 906f with biasing member 924a, 924b, 924c, 924e, 924f. As depicted in FIG. 9F, a blade throat 930f defines an angle 935f with respect to a longitudinal axis of the blade holder 905f of approximately 38°. The angle 935f may be between approximately 30° and approximately 45°. The blade throat 930f may define an angle 935f with respect to a longitudinal axis of the blade holder 905f between 25° and 50°. The blade throat 930f may be approximately 0.188 inches, thereby, the blade throat 930f limits exposure to the cutting edge of the blade 910f. The cutting edge of the blade 910f may define an angle (e.g., angle 813c of FIG. 8C) with respect to a longitudinal axis of the blade holder 905f of approximately 20°. The cutting edge of the blade 910f may define an angle 813c with respect to a longitudinal axis of the blade holder 905f between 15° and 25°.

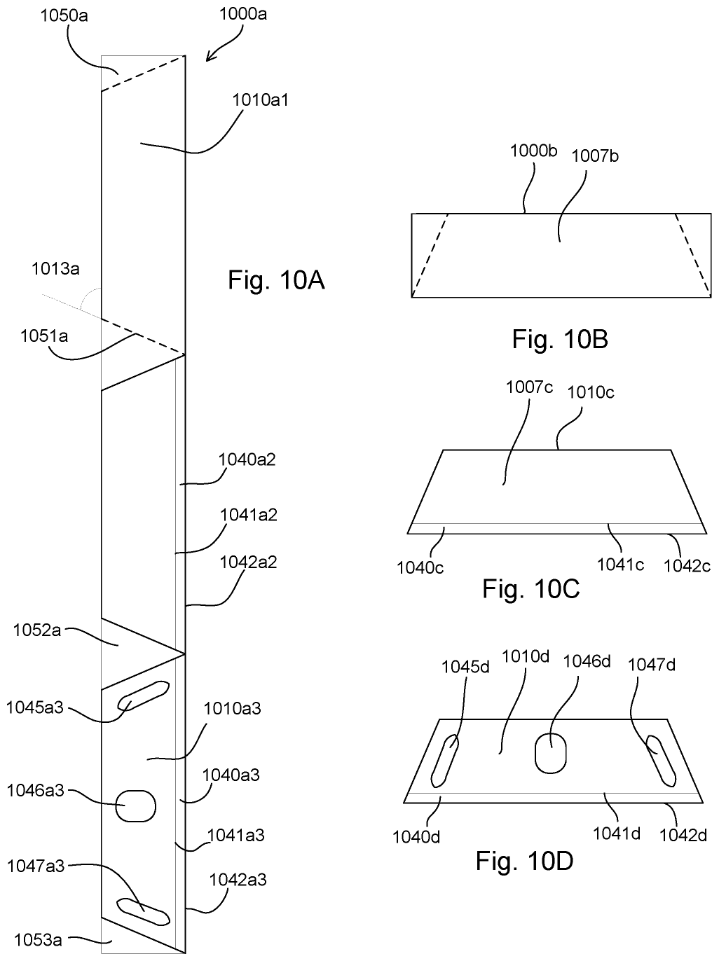

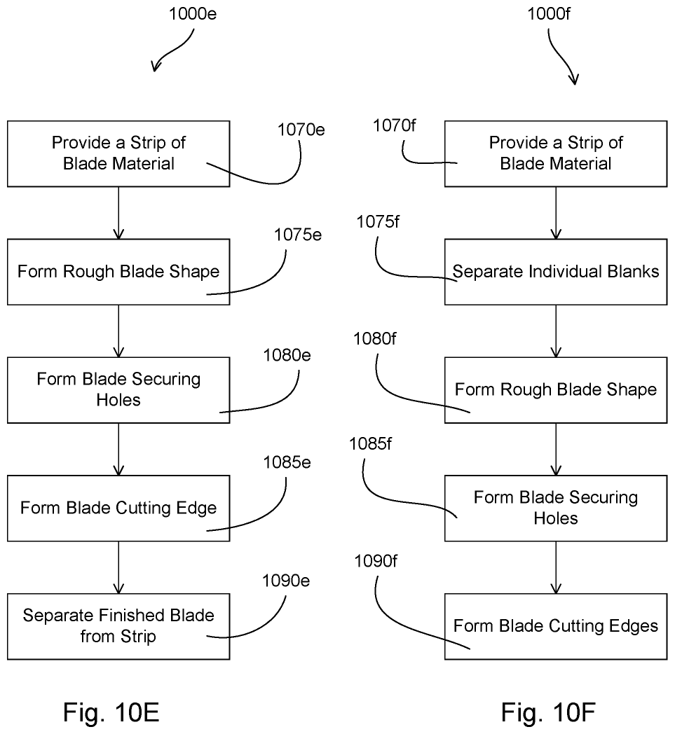

Turning to FIGS. 10A and 10E, a method 1000e of manufacturing a blade 1010a3 for use in a safety utility knife assembly (e.g. safety utility knife assembly 800a of FIG. 8A) may include providing a strip of blade material 1000a (block 1070e). A rough blade shape 1010a1 may be formed by removing material 1050a (block 1075e). Blade securing holes 1045a3, 1046a3, 1047a3 may be formed in the rough blade shape 1010a1 by any suitable method, such as laser cutting, water jet cutting, machining, drilling, stamp shearing, etc. (block 1080e). A sharpened portion 1040a2, 1040a3 may be formed by any suitable method, such as those disclosed in U.S. Pat. Nos. 4,265,055, 5,842,387, 6,860,796 or 8,206,199, for example (block 1085e). The sharpened portion 1040a2, 1040a3 may define a shoulder 1041a2, 1041a3 and a cutting edge 1042a2, 1042a3. The blade 1010a3 may be separated from the strip of blade material 1000a by removing material 1052a, 1053a (block 1090e). A blade end 1051a may form an angle 1013a with respect to a linear edge of the strip of blade material 1000a of approximately 60°. The angle 1013a may be between approximately 55° and approximately 70°.

With reference now to FIGS. 10B-10D and 10F, a method 1000f of manufacturing a blade 1010d for use in a safety utility knife assembly (e.g. safety utility knife assembly 800a of FIG. 8A) may include providing a strip of blade material 1000a (block 1070f). Blade blanks 1000b may be formed from the strip of blade material 1000a (block 1075f). Rough blade shapes 1007b may be formed from the blade blanks 1000b (block 1080f). Blade securing holes 1045b, 1046b, 1047b may be formed in the rough blade shape 1000b by any suitable method, such as laser cutting, water jet cutting, machining, drilling, stamp shearing, etc. (block 1085f). A sharpened portion 1040c, 1040d may be formed by any suitable method, such as those disclosed in U.S. Pat. Nos. 4,265,055, 5,842,387, 6,860,796 or 8,206,199, for example (block 1090f). The sharpened portion 1040c, 1040d may define a shoulder 1041c, 1041d and a cutting edge 1042c, 1042c.

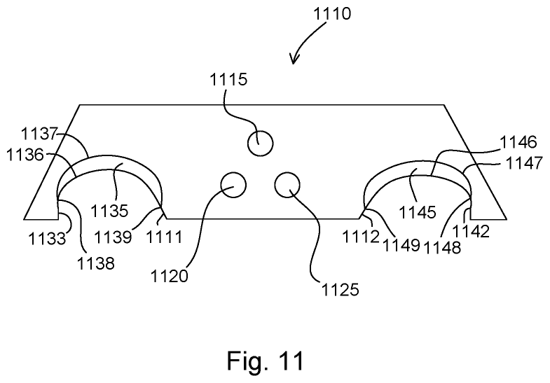

With reference to FIG. 11, a safety utility blade 1110 for use in the safety utility knife assembly 800a of FIG. 8A may have a body 1110a formed from a relatively thin and substantially flat material 1000a, such as ceramic, heat treated carbon steel, ceramic coated steel, stainless steel, Teflon coated material, etc. For example, the material 1000a may be approximately 0.025 inches thick. A blade blank (e.g. blade blank 1000a, 1000b of FIGS. 10A and 10B, respectively) may be 1.0964567 inches from a first end 1050a to a second end 1051a and 0.3917323 inches from a top side 1010c to a bottom side 1042d. The safety utility blade may include blade securing holes 1115, 1120, 1125. As described herein the blade securing holes 1115, 1120, 1125 may, at least in part, secure a safety utility blade 1110 to a safety utility knife cutting head (e.g., safety utility knife cutting head 920j of FIG. 9J). The safety utility blade 1110 may be formed from a suitable material 1000a for retaining a sharpened edge 1136, 1137, and, when that material 1000a is metal, the body 1110a preferably has a thickness 106b of at least 0.0156 inches and preferably not greater than about 0.0313 inches. What might be characterized as a “heavy-duty” safety utility blade 100 is approximately 0.025 inches thick, and the thickness 106b for what might be characterized as a “regular duty” safety utility blade 1110 is approximately 0.017 inches. The sharpened portion 1135, 1145 is approximately 0.0492 inches high.

With further reference to FIG. 11, the first sharpened portion 1135 of the safety utility blade 1110 may include a first shoulder 1137, a first cutting edge 1136, a first heal 1139 and a first toe 1138. The safety utility blade may include a first edge 1111 extending from the first heal 1139 to the bottom side. The safety utility blade 1110 may further include a first inner edge 1133 that extends from the first toe 1139 to the bottom side and may have a thickness that is greater than the first sharpened portion 1135 and less than or equal to the thickness 106b of the body 1005a. The first edge 1111 and the first inner edge 1133 may cooperate to limit access to the cutting edge 1136 while the safety utility blade 1110 is being used in the safety utility knife assembly 800a, while the safety utility blade 1110 is being inserted into the safety utility knife assembly 800a, while the safety utility blade 1110 is being removed from the safety utility knife assembly 800a and while the safety utility blade 1110 is being handled while removed from the safety utility knife assembly 800a.

With further reference to FIG. 11, the safety utility blade 1110 may include a second sharpened portion 1145 which may include a second shoulder 1147, a second cutting edge 1146, a second heal 1149 and a second toe 1148. The safety utility blade 1110, 110b may include a second edge 1112 extending from the second heal 1149 to the bottom side. The safety utility blade 1110 may further include a second inner edge 1143 that extends from the second toe 1149 to the bottom side and may have a thickness that is greater than the second sharpened portion 1145 and less than or equal to the thickness 106b of the body 1005a. As depicted in FIG. 1b, the cutting edge 136b may be defined by a third sharpened portion 135b1 extending from a third shoulder 137b1 and a fourth sharpened portion 135b2 extending from a fourth shoulder 137b2. It should be understood that either of the cutting edges 1136, 1146 may be formed similar to cutting edge 136b. The second edge 1112 and the second inner edge 1143 may cooperate to limit access to the cutting edge 1146 while the safety utility blade 1110 is being used in the safety utility knife assembly 800a, while the safety utility blade 1110 is being inserted into the safety utility knife assembly 800a, while the safety utility blade 1110 is being removed from the safety utility knife assembly 800a and while the safety utility blade 1110 is being handled while removed from the safety utility knife assembly 800a. A safety utility blade 1110 may be manufactured similar to the safety utility blade 100 as described with reference to FIGS. 3A-3E and 4A-4D.

The figures depict preferred embodiments of safety blades for use in utility knife assemblies, utility knife assemblies and methods of manufacturing. One skilled in the art will readily recognize from the corresponding written description that alternative embodiments of the structures and methods illustrated herein may be employed without departing from the principles described.

Upon reading this disclosure, those of skill in the art will appreciate still additional alternative structural and functional designs for safety blades for use in utility knife assemblies, utility knife assemblies and methods of manufacturing. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the apparatuses and methods disclosed herein without departing from the spirit and scope defined in the appended claims.

What is claimed is:

1. A replaceable safety blade for use within a utility knife assembly, comprising:
a blade body having a cutting edge, wherein the blade body and the cutting edge define a contiguous piece of metal;
a blade attachment having a blade tip and a first edge, wherein the first edge and the blade tip are juxtapose on opposite ends of the cutting edge, wherein the blade attachment further includes a bottom edge proximate the cutting edge and defining a width of the blade attachment; and
a handle adaptor having a handle engagement portion with a handle securing mechanism, wherein the handle adaptor is secured to the blade attachment portion, wherein the handle engagement portion is configured to removably secure the replaceable safety blade to a handle, wherein the handle engagement portion extends from the bottom edge of the blade attachment, wherein a width of the handle adaptor is less than the width of the blade attachment, wherein the handle engagement and the blade tip extend beyond the blade cutting edge, and wherein the blade tip portion and an edge of the handle adaptor form a first blade throat which limits exposure to a blade cutting edge.

2. The safety blade as in claim 1 wherein the blade cutting edge forms an angle with respect to the handle engagement portion to encourage material being cut to move toward the blade cutting edge.

3. The safety blade as in claim 1 wherein an inner edge of the blade tip extends from a toe of the blade cutting edge.

4. The safety blade as in claim 1 wherein the first edge of the blade attachment extends from a heel of the blade cutting edge.

5. The safety blade as in claim 1 wherein the contiguous piece of metal is selected from the group consisting of: carbon steel, heat treated metal, heat treated carbon steel and stainless steel.

6. The safety blade as in claim 1 wherein the blade cutting edge has a triangular shaped cross section.

7. The safety blade as in claim 1 wherein the blade tip has a radius approximately 0.03937 inches, and a thickness of greater than 0.017 inches.

8. A method of manufacturing the safety blade for use within a safety utility knife assembly, the method comprising;
providing a strip of blade material;
forming a blade cutting edge;
forming a rough blade shape from the strip of blade material, wherein the rough blade shape comprises a blade body;
forming a blade attachment having a blade tip and a first edge, wherein the first edge and the blade tip are juxtapose on opposite ends of the cutting edge, wherein the blade attachment further includes a bottom edge proximate the cutting edge and defining a width of the blade attachment; and
forming a handle adaptor having a handle engagement portion with a handle securing mechanism, wherein the handle adaptor is secured to the blade attachment portion, wherein the handle engagement portion is configured to removably secure the replaceable safety blade to a handle, wherein the handle engagement portion extends from the bottom edge of the blade attachment, wherein a width of the handle adaptor is less than the width of the blade attachment, wherein the handle engagement and the blade tip extend beyond the blade cutting edge, and wherein the blade tip portion and an edge of the handle adaptor form a first blade throat which limits exposure to a blade cutting edge.

9. The method as in claim 8 wherein an inner edge of the blade attachment forms an angle with respect to a bottom of the blade attachment to encourage material being cut to move toward the blade cutting edge.

10. The method as in claim 8 wherein the strip of blade material is selected from the group consisting of: carbon steel, heat treated metal, heat treated carbon steel, stainless steel and ceramic.

11. The method as in claim 8 wherein the blade cutting edge has a triangular shaped cross section.

12. The method as in claim 8 wherein the first blunt tip has a radius approximately 0.03937 inches, and a thickness of greater than 0.017 inches.

13. The method as in claim 8 wherein forming the blade cutting edge includes using a grinding drum.

14. The method as in claim 8 wherein forming the blade cutting edge includes using a grinding and honing wheel.

15. A safety utility knife assembly, comprising:
a replaceable safety blade as in claim 1; and
a handle for engagement with the handle engagement of the handle adaptor.

16. A safety utility knife assembly as in claim 15, wherein the handle cooperates with the handle engagement portion to secure the replaceable safety blade in a predetermined position.

17. A safety utility knife assembly as in claim 15 wherein the handle engagement includes a handle engagement mechanism that secures the replaceable safety blade to the handle.

18. A safety utility knife assembly as in claim 15 wherein the blade throat forms an angle with respect to a longitudinal axis of the blade attachment portion that is greater than approximately 25 degrees.

19. A safety utility knife assembly as in claim 15 wherein the blade body includes at least one hole extending through the blade body, and wherein the blade attachment portion is co-molded to the safety blade such that material of the blade attachment portion extends through the at least one hole.

20. A safety utility knife assembly as in claim 15 wherein the blade body includes at least one hole extending through the blade body, and wherein the blade attachment portion includes two halves arranged in a clamshell configuration, and wherein material of the blade attachment portion extends through the at least one hole of the blade body when the two halves of the blade attachment are secured together.
